(19) United States
(12) Patent Application Publication
(10) Pub. No.: US 2026/0159251 A1
(43) Pub. Date: Jun. 11, 2026

(54) AIRCRAFT COWLING SUPPORT

(71) Applicant: Paul Ivan Miller, Mesa, AZ (US)

(72) Inventor: Paul Ivan Miller, Mesa, AZ (US)

(21) Appl. No.: 19/408,010

(22) Filed: Dec. 3, 2025

Related U.S. Application Data
(60) Provisional application No. 63/729,785, filed on Dec. 9, 2024.

(51) Int. Cl. B64F 5/50; B64D 29/06

(52) U.S. Cl. CPC B64F 5/50; B64D 29/06

(57) ABSTRACT

A cowling support for a fan cowling of an aircraft engine is provided. A cowling support pole having an elongated rod telescopically arranged within a tubular base supports the fan cowling before employing hold-open rods to hold the fan cowling open for maintenance and/or inspection. An adapter bracket plate is pivotally secured to a top end of the elongated rod and supports a lower edge of the fan cowling in an open position. A tripod leg arrangement is secured to the tubular base and engages a ground surface.

### CROSS REFERENCE TO RELATED APPLICATION

This application claims priority to U.S. Provisional Patent Application entitled “AIRCRAFT COWLING SUPPORT,” Ser. No. 63/729,785, filed Dec. 9, 2024, the disclosure of which is hereby incorporated entirely herein by reference.

### BACKGROUND OF THE INVENTION

### Technical Field

This invention relates to a cowling support and a method of supporting a fan cowling of an aircraft engine.

### State of the Art

Large transport category aircraft, primarily manufactured by Airbus and Boeing, generally utilize twin jet-powered engines encased inside heavy composite cowlings. These cowlings, generally called fan cowlings, on the forward part of the engine are located directly behind the inlet, and thrust reversers are located directly behind the fan cowlings. Thrust reversers can only be opened after the fan cowlings are opened. Hydraulic pumps are used to open the thrust reversers. Access to the engine surfaces of the enclosed area of the thrust reversers is restricted unless the fan cowlings are opened first.

Fan cowlings utilize several flush mounted “hook and loop” type latches. The latches are located at a bottom portion of the cowlings. The latches draw close the fan cowling halves together. The fan cowlings are hinged at the top of the cowlings to the engine pylons. These fan cowlings are manually opened. Hold-open rods are located on the inside panel of the fan cowling and are used to prop open the fan cowling to allow access for the performance of maintenance and/or inspection. One hold-open rod is located at the forward part of the fan cowling, and one is located at the rear part of the fan cowling. The hold-open rod ends are engaged to a locking part located on the engine assembly and must be engaged and locked to prevent the closure of the fan cowling and for proper access.

The operator must manually engage the hold-open rods while the load of the fan cowling is supported on the operator's hip (hip hold). The hip hold is physically difficult, awkward, and dangerous for operators manually opening the fan cowling. The fan cowlings can weigh above about eighty to ninety pounds (about thirty-six to forty-one kilograms) leading to compounded, adverse physical health risks of the operator. The operator, all the while performs these tasks in adverse environmental working conditions, especially for operators working in environments, such as cold inclement outdoor weather, low lighting, oily slippery surfaces found on aircraft ramps, rainy or snowy-icy conditions, and the like. Engaging one hold-open rod only, namely the forward or the rear hold-open rod for a long period, causes composite delamination to the cowling, thus requiring both hold-open rods to be fully deployed and engaged.

Accordingly, what is needed is an easier and safer method and apparatus for supporting an aircraft fan cowling.

### DISCLOSURE OF THE INVENTION

The disclosed invention relates to a cowling support for supporting a fan cowling in order to provide an easier and safer method and apparatus for supporting a fan cowling during maintenance and/or inspection.

Disclosed is a cowling support for a fan cowling of an aircraft engine in an open position, comprising: a cowling support pole provided with a telescopically arranged elongated rod member slidably received within an elongated tubular base member supported by a base pad on a ground surface; and an adapter bracket plate member pivotally secured to a top end portion of the telescopically arranged elongated rod member of the cowling support pole, wherein the adapter bracket plate member is secured to a lower edge portion of the fan cowling and supports the fan cowling via the adapter bracket plate member being pivotally secured to the cowling support pole.

A lockable detent mechanism may be provided on the elongated tubular base member in order to lock the telescopically arranged elongated rod member within the elongated tubular base member in various locking positions. A support leg arrangement may be provided about a middle portion of the elongated tubular base member. A plurality of leg members may extend angularly downward from a central hub member provided on the middle portion of the elongated tubular base member and may engage the ground surface with a plurality of respective feet members of the plurality of leg members.

The adapter bracket plate member may be provided with a U-shaped body portion having outwardly extending flanges. The outwardly extending flanges may be each provided with an aperture. An actuatable holding pin may pivotably secure the top end portion of the telescopically arranged elongated rod member with the adapter bracket plate member. The U-shaped body portion may be provided with a first planar flange portion, a second planar flange portion extending perpendicular and upward from the first planar flange portion and a third planar flange portion extending inward from the second planar flange portion and parallel to the first planar flange portion.

A lanyard retraction device may be secured to the adapter bracket plate member. A retractable lanyard having a lanyard handle on a distal end may extend from the lanyard retraction device.

Disclosed is a method of supporting a fan cowling of an aircraft engine in an open position, the method comprising the following steps: providing a cowling support pole with a telescopically arranged elongated rod member slidably received within an elongated tubular base member supported by a base pad on a ground surface; pivotally securing an adapter bracket plate member to a top end portion of the telescopically arranged elongated rod member of the cowling support pole; securing the adapter bracket plate member to a lower edge portion of the fan cowling; and supporting the fan cowling via the adapter bracket plate member being pivotally secured to the cowling support pole.

The method may further comprise providing a lockable detent mechanism on the elongated tubular base member in order to lock the telescopically arranged elongated rod member within the elongated tubular base member in various locking positions. The method may further comprise providing a support leg arrangement about a middle portion of the elongated tubular base member. The method may further comprise providing a plurality of leg members extending angularly downward from a central hub member provided on the middle portion of the elongated tubular base member and engaging the ground surface with a plurality of respective feet members of the plurality of leg members.

The method may further comprise providing the adapter bracket plate member with a U-shaped body portion having outwardly extending flanges. The method may further comprise providing the outwardly extending flanges with respective apertures. The method may further comprise providing an actuatable holding pin pivotably securing the top end portion of the telescopically arranged elongated rod member with the adapter bracket plate member. The method may further comprise providing the U-shaped body portion with a first planar flange portion, a second planar flange portion extending perpendicular and upward from the first planar flange portion and a third planar flange portion extending inward from the second planar flange portion and parallel to the first planar flange portion.

The method may further comprise securing a lanyard retraction device to the adapter bracket plate member. The method may further comprise extending a retractable lanyard having a lanyard handle on a distal end from the lanyard retraction device.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 is a plan view of a cowling support pole supporting a fan cowling according to an embodiment;

FIG. 2 is a perspective view of an adapter bracket plate member mounted to a fan cowling according to an embodiment;

FIG. 3A is a perspective view of an adapter bracket plate member mounted to a fan cowling according to an embodiment;

FIG. 3B is a partial plan view of an adapter bracket plate member according to an embodiment;

FIG. 4 is a perspective view of an adapter bracket plate member according to an embodiment;

FIG. 5 is a perspective view of an adapter bracket plate member according to an embodiment;

FIG. 6 is a perspective view of an adapter bracket plate member according to an embodiment;

FIG. 7 is a perspective view of an adapter bracket plate member according to an embodiment;

FIG. 8 is a perspective view of an adapter bracket plate member according to an embodiment;

FIG. 9 is a perspective view of an adapter bracket plate member according to an embodiment;

FIG. 10 is a perspective view of a cowling support pole according to an embodiment;

FIG. 11 is a perspective view of an actuatable holding pin for use with an adapter bracket plate member according to an embodiment; and

FIG. 12 is a flow chart depicting a method of using a cowling support pole for supporting a fan cowling according to an embodiment.

### DETAILED DESCRIPTION OF EMBODIMENTS OF THE INVENTION

As discussed above, embodiments of the present invention relate to a cowling support for supporting a fan cowling in order to provide an easier and safer method and apparatus for supporting a fan cowling during maintenance and/or inspection. A cowling support pole having an adapter bracket plate is secured to the fan cowling and supports the fan cowling via the adapter bracket plate.

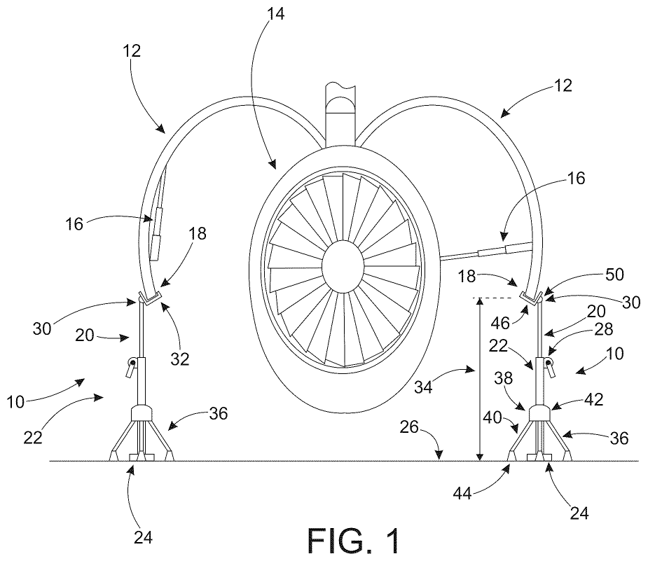

As shown in FIG. 1, a cowling support pole 10 supports a fan cowling 12 of an aircraft engine 14 in an open position in order to allow for maintenance and/or inspection. Once the fan cowling 12 is supported by the cowling support pole 10, an operator may place a hold-open rod 16 of the aircraft engine 14 in a position to support the fan cowling 12 in an open position (see right hand side of FIG. 1 showing the hold-open rod 16 in place). By first placing the cowling support pole 10 in position under a lower edge portion 18 of the fan cowling 12, the operator avoids having to hold open the fan cowling 12 with a part of the operator's body in order to place the hold-open rod 16 in position on the aircraft engine 14.

The cowling support pole 10 is provided with a telescopically arranged elongated rod member 20 slidably received within an elongated tubular base member 22 supported by an elastomeric base pad 24, such as rubber, on a ground surface 26. A lockable detent mechanism 28 is provided on the elongated tubular base member 22 in order to select various locking positions between the telescopically arranged elongated rod member 20 and the elongated tubular base member 22.

A top end portion 30 of the telescopically arranged elongated rod member 20 of the cowling support pole 10 is pivotally secured to a first adapter bracket plate member 32. The first adapter bracket plate member 32 is secured to the lower edge portion 18 of the fan cowling 12 and supports the fan cowling 12 via the first adapter bracket plate member 32 being pivotally secured to the cowling support pole 10. Since the telescopically arranged elongated rod member 20 is slidably received within the elongated tubular base member 22, a height position 34 of the first adapter bracket plate member 32 is selectable by the operator to accommodate various open positions of the fan cowling 12 for various maintenance and/or inspection as required.

A tripod support leg arrangement 36 is provided about a middle portion 38 of the elongated tubular base member 22. A plurality of leg members 40 extend angularly downward from a central hub member 42 and engage the ground surface 26 with a plurality of respective feet members 44.

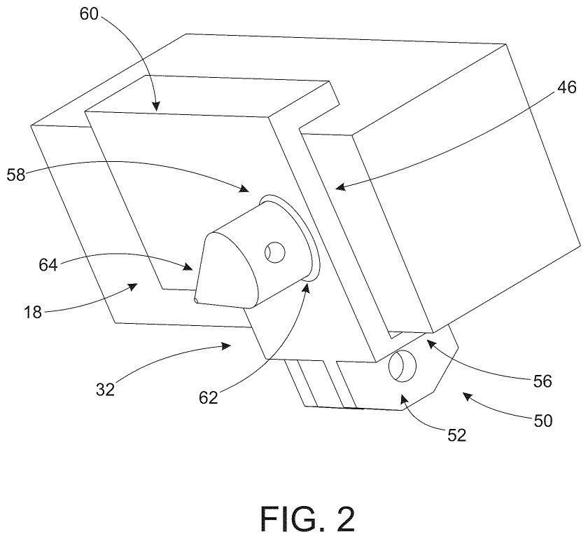

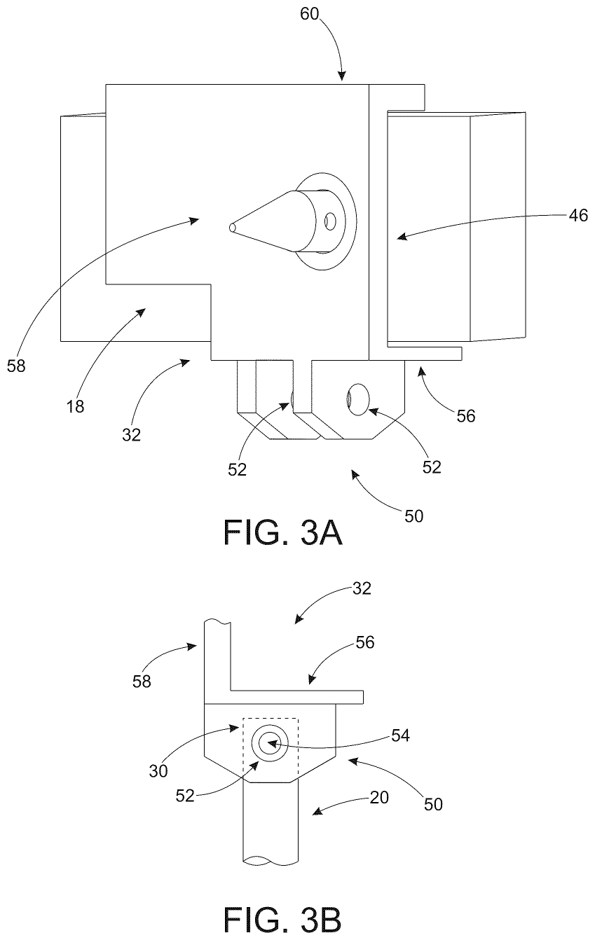

As shown in FIGS. 1, 2, 3A and 3B, the first adapter bracket plate member 32 is provided with a generally U-shaped body portion 46 having outwardly extending flanges 50. The outwardly extending flanges 50 are each provided with an aperture 52 in order to receive an actuatable holding pin 54 to pivotably secure the top end portion 30 of the telescopically arranged elongated rod member 20 with the first adapter bracket plate member 32. As shown in FIG. 3B, the actuatable holding pin 54 is arranged through each aperture 52 of the outwardly extending flanges 50 and pivotably secures the top end portion 30 of the telescopically arranged elongated rod member 20 with the first adapter bracket plate member 32.

The generally U-shaped body portion 46 of the first adapter bracket plate member 32 is provided with a first planar flange portion 56, a second middle planar flange portion 58 extending perpendicular and upward from the first planar flange portion 56 and a third planar flange portion 60 extending inward from the second middle planar flange portion 58 and parallel to the first planar flange portion 56.

The second middle planar flange portion 58 is provided with an aperture 62 to accommodate a pointed guide pin 64 extending from the lower edge portion 18 of the fan cowling 12 in order to secure the first adapter bracket plate member 32 against movement along the lower edge portion 18 of the fan cowling 12.

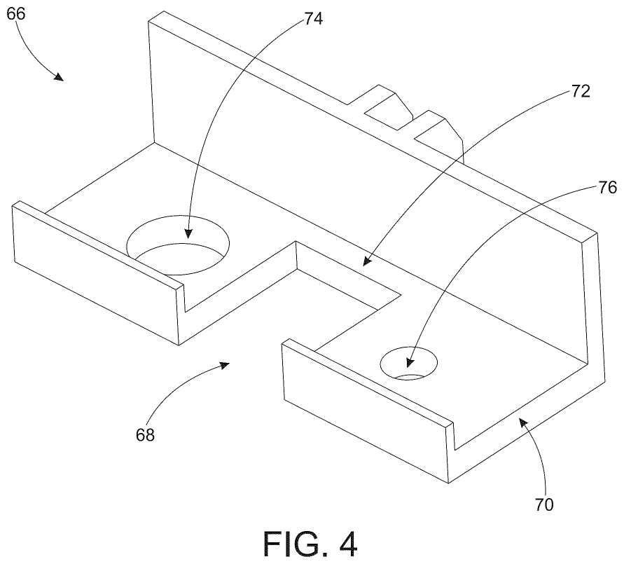

FIG. 4 shows another embodiment having a second adapter bracket plate member 66 provided with a first open slotted portion 68 extending inwardly into a first middle planar flange portion 70 and located within a first central portion 72 of the first middle planar flange portion 70. A first aperture 74 is provided within the first middle planar flange portion 70 on one side of the first open slotted portion 68 and a second aperture 76 is provided on an opposite side of the first open slotted portion 68.

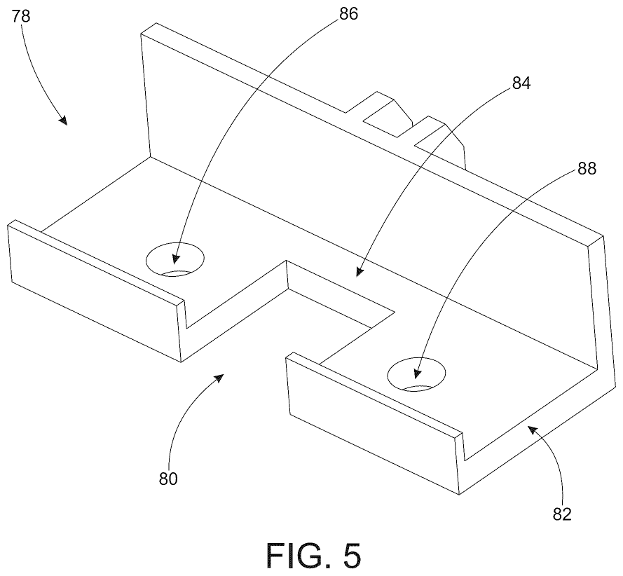

FIG. 5 shows another embodiment having a third adapter bracket plate member 78 provided with a second open slotted portion 80 extending inwardly into a second middle planar flange portion 82 and located within a second central portion 84 of the second middle planar flange portion 82. A third aperture 86 is provided within the second middle planar flange portion 82 on one side of the second open slotted portion 80 and a fourth aperture 88 is provided on an opposite side of the second open slotted portion 80.

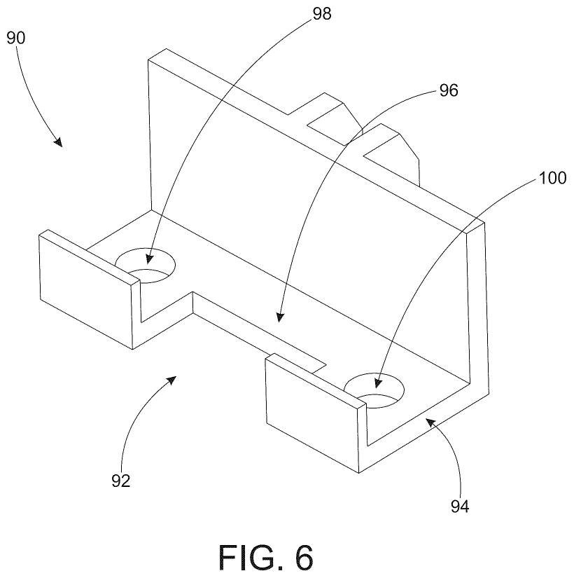

FIG. 6 shows another embodiment having a fourth adapter bracket plate member 90 provided with an elongated open slotted portion 92 extending inwardly into a third middle planar flange portion 94 and located within a third central portion 96 of the third middle planar flange portion 94. A fifth aperture 98 is provided within the third middle planar flange portion 94 on one side of the elongated open slotted portion 92 and a sixth aperture 100 is provided on an opposite side of the elongated open slotted portion 92.

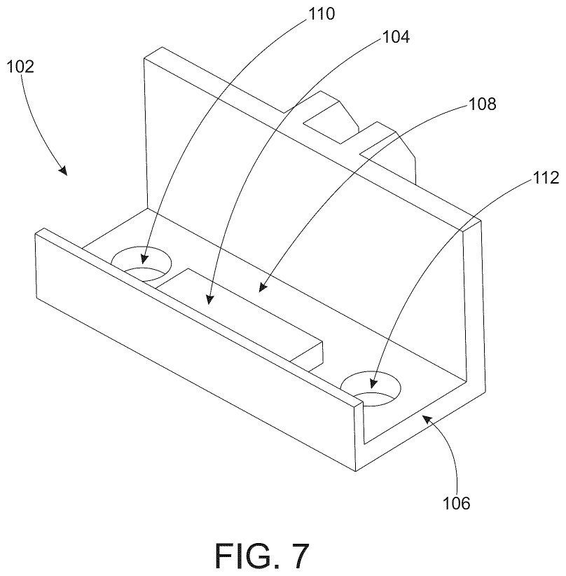

FIG. 7 shows another embodiment having a fifth adapter bracket plate member 102 provided with an elongated raised portion 104 provided on a fourth middle planar flange portion 106 and located within a fourth central portion 108 of the fourth middle planar flange portion 106. A seventh aperture 110 is provided within the fourth middle planar flange portion 106 on one side of the elongated raised portion 104 and an eighth aperture 112 is provided on an opposite side of the elongated raised portion 104.

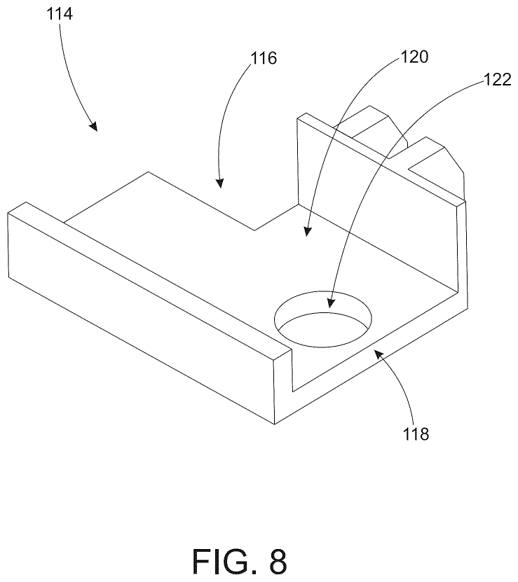

FIG. 8 shows another embodiment having a sixth adapter bracket plate member 114 provided with an open-ended slotted corner portion 116 within a fifth middle planar flange portion 118 and located on one side of a fifth central portion 120 of the fifth middle planar flange portion 118. A nineth aperture 122 is provided within the fifth middle planar flange portion 118 on an opposite side from the open-ended slotted corner portion 116 about the fifth central portion 120 of the fifth middle planar flange portion 118.

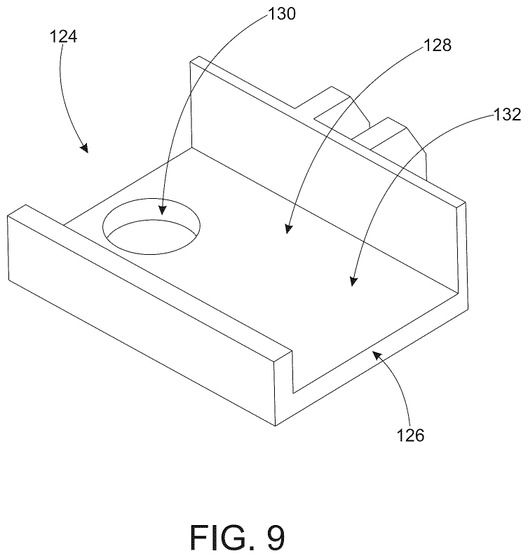

FIG. 9 shows another embodiment having a seventh adapter bracket plate member 124 provided with a tenth aperture 130 within a sixth middle planar flange portion 126 and located on one side of a sixth central portion 128 of the sixth middle planar flange portion 126. The tenth aperture 130 is provided within the sixth middle planar flange portion 126 on an opposite side from a planar flange region 132 of the sixth middle planar flange portion 126.

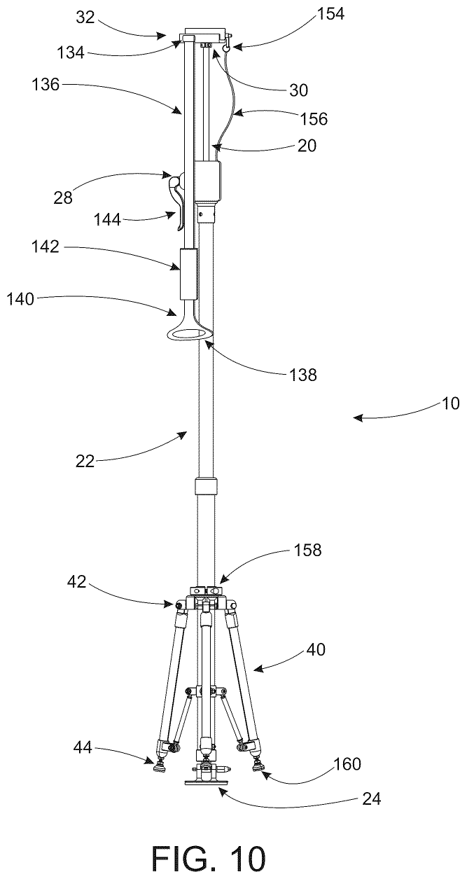

FIG. 10 shows the cowling support pole 10 having the telescopically arranged elongated rod member 20 with the top end portion 30 secured to the first adapter bracket plate member 32. A lanyard retraction device 134 having a LED light (not shown) is secured to the first adapter bracket plate member 32. The lanyard retraction device 134 is provided with a retractable lanyard 136 extending therefrom. The retractable lanyard 136 may be of 40 to 48 inches in length and extends along both the telescopically arranged elongated rod member 20 and the elongated tubular base member 22.

The retractable lanyard 136 is provided with a lanyard handle 138 on a distal end 140 thereof and a warning placard 142 adjacent the lanyard handle 138 at the distal end 140. The warning placard 142 is riveted the retractable lanyard 136 for durability and indicates removing the cowling support pole 10 from the aircraft engine 14 after maintenance and/or inspection is complete and before flight.

The lockable detent mechanism 28 is provided with an adjustable handle 144 for actuation. A bubble level 158 is provided on the central hub member 42 in order to allow the operator to position the cowling support pole 10 in a vertical manner relative to the fan cowling 12. A plurality of elastomeric pads 160 are respectively provided beneath the plurality of respective feet members 44.

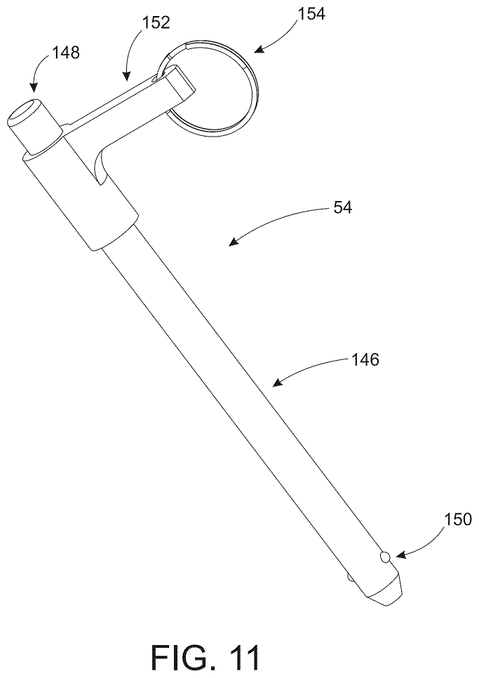

As shown in FIG. 11, the actuatable holding pin 54 is provided with an elongated shaft member 146, an actuatable button member 148, detent ball members 150 and a lateral pull handle 152 with a retaining ring 154. As shown in FIG. 10, the retaining ring 154 is secured to a quick release pin tether cable 156 which is fixedly secured to the lockable detent mechanism 28.

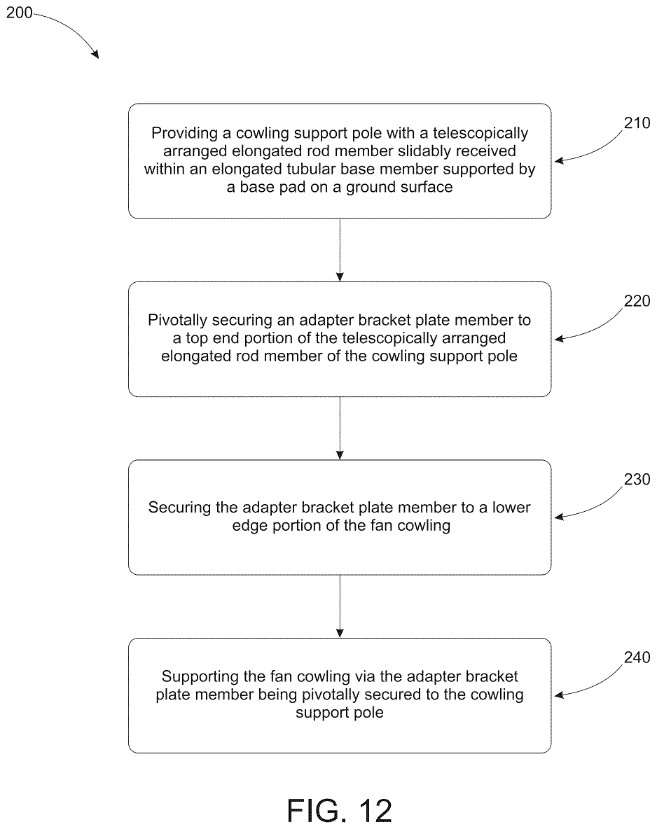

FIG. 12 is a block diagram of steps of a method 200 of supporting a fan cowling of an aircraft engine in an open position. Method 200 comprises: providing a cowling support pole with a telescopically arranged elongated rod member slidably received within an elongated tubular base member supported by a base pad on a ground surface (Step 210); pivotally securing an adapter bracket plate member to a top end portion of the telescopically arranged elongated rod member of the cowling support pole (Step 220); securing the adapter bracket plate member to a lower edge portion of the fan cowling (Step 230); and supporting the fan cowling via the adapter bracket plate member being pivotally secured to the cowling support pole (Step 240).

The method may further comprise providing a lockable detent mechanism on the elongated tubular base member in order to lock the telescopically arranged elongated rod member within the elongated tubular base member in various locking positions. The method may further comprise providing a support leg arrangement about a middle portion of the elongated tubular base member. The method may further comprise providing a plurality of leg members extending angularly downward from a central hub member provided on the middle portion of the elongated tubular base member and engaging the ground surface with a plurality of respective feet members of the plurality of leg members.

The method may further comprise providing the adapter bracket plate member with a U-shaped body portion having outwardly extending flanges. The method may further comprise providing the outwardly extending flanges with respective apertures. The method may further comprise providing an actuatable holding pin pivotably securing the top end portion of the telescopically arranged elongated rod member with the adapter bracket plate member.

The method may further comprise providing the U-shaped body portion with a first planar flange portion, a second planar flange portion extending perpendicular and upward from the first planar flange portion and a third planar flange portion extending inward from the second planar flange portion and parallel to the first planar flange portion. The method may further comprise securing a lanyard retraction device to the adapter bracket plate member. The method may further comprise extending a retractable lanyard having a lanyard handle on a distal end from the lanyard retraction device.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A cowling support for a fan cowling of an aircraft engine in an open position, comprising:
a cowling support pole provided with a telescopically arranged elongated rod member slidably received within an elongated tubular base member supported by a base pad on a ground surface; and
an adapter bracket plate member pivotally secured to a top end portion of the telescopically arranged elongated rod member of the cowling support pole, wherein the adapter bracket plate member is secured to a lower edge portion of the fan cowling and supports the fan cowling via the adapter bracket plate member being pivotally secured to the cowling support pole.

2. The cowling support according to claim 1, wherein a lockable detent mechanism is provided on the elongated tubular base member in order to lock the telescopically arranged elongated rod member within the elongated tubular base member in various locking positions.

3. The cowling support according to claim 1, wherein a support leg arrangement is provided about a middle portion of the elongated tubular base member.

4. The cowling support according to claim 3, wherein a plurality of leg members extend angularly downward from a central hub member provided on the middle portion of the elongated tubular base member and engage the ground surface with a plurality of respective feet members of the plurality of leg members.

5. The cowling support according to claim 1, wherein the adapter bracket plate member is provided with a U-shaped body portion having outwardly extending flanges.

6. The cowling support according to claim 5, wherein the outwardly extending flanges are each provided with an aperture.

7. The cowling support according to claim 6, wherein an actuatable holding pin pivotably secures the top end portion of the telescopically arranged elongated rod member with the adapter bracket plate member.

8. The cowling support according to claim 5, wherein the U-shaped body portion is provided with a first planar flange portion, a second planar flange portion extending perpendicular and upward from the first planar flange portion and a third planar flange portion extending inward from the second planar flange portion and parallel to the first planar flange portion.

9. The cowling support according to claim 1, wherein a lanyard retraction device is secured to the adapter bracket plate member.

10. The cowling support according to claim 9, wherein a retractable lanyard having a lanyard handle on a distal end extends from the lanyard retraction device.

11. A method of supporting a fan cowling of an aircraft engine in an open position, the method comprising the following steps:
providing a cowling support pole with a telescopically arranged elongated rod member slidably received within an elongated tubular base member supported by a base pad on a ground surface;
pivotally securing an adapter bracket plate member to a top end portion of the telescopically arranged elongated rod member of the cowling support pole;
securing the adapter bracket plate member to a lower edge portion of the fan cowling; and
supporting the fan cowling via the adapter bracket plate member being pivotally secured to the cowling support pole.

12. The method according to claim 11, wherein the method further comprises providing a lockable detent mechanism on the elongated tubular base member in order to lock the telescopically arranged elongated rod member within the elongated tubular base member in various locking positions.

13. The method according to claim 11, wherein the method further comprises providing a support leg arrangement about a middle portion of the elongated tubular base member.

14. The method according to claim 13, wherein the method further comprises providing a plurality of leg members extending angularly downward from a central hub member provided on the middle portion of the elongated tubular base member and engaging the ground surface with a plurality of respective feet members of the plurality of leg members.

15. The method according to claim 11, wherein the method further comprises providing the adapter bracket plate member with a U-shaped body portion having outwardly extending flanges.

16. The method according to claim 15, wherein the method further comprises providing the outwardly extending flanges with respective apertures.

17. The method according to claim 16, wherein the method further comprises providing an actuatable holding pin pivotably securing the top end portion of the telescopically arranged elongated rod member with the adapter bracket plate member.

18. The method according to claim 15, wherein the method further comprises providing the U-shaped body portion with a first planar flange portion, a second planar flange portion extending perpendicular and upward from the first planar flange portion and a third planar flange portion extending inward from the second planar flange portion and parallel to the first planar flange portion.

19. The method according to claim 11, wherein the method further comprises securing a lanyard retraction device to the adapter bracket plate member.

20. The method according to claim 19, wherein the method further comprises extending a retractable lanyard having a lanyard handle on a distal end from the lanyard retraction device.
